(19) United States
(12) Patent Application Publication
(10) Pub. No.: US 2008/0320405 A1
(43) Pub. Date: Dec. 25, 2008

(54) METHODS AND APPARATUS FOR PROVIDING CONTEXT SENSITIVE TEMPLATES FOR A WEB BASED WORKFLOW DESIGN

(75) Inventors: Adriaan Van Wyk, Strubensvalley (ZA); Olaf Wagner, Issaquah, WA (US)

Correspondence Address: BELL, BOYD & LLOYD, LLP, P.O. Box 1135, CHICAGO, IL, 60690, US

(73) Assignee: SOURCECODE TECHNOLOGY HOLDING, INC., Redmond, WA (US)

(21) Appl. No.: 12/054,241

(22) Filed: Mar. 24, 2008

Related U.S. Application Data
(60) Provisional application No. 60/939,272, filed on May 21, 2007.
(60) Provisional application No. 60/896,417, filed on Mar. 22, 2007.

(51) Int. Cl. G06F 3/048

(52) U.S. Cl. 715/764

(57) ABSTRACT

The present disclosure provides methods and apparatuses for providing context sensitive templates for a web based workflow design. Using the methods and apparatus herein, users can create business processes using pre-built templates that define process logic via a web browser. This allows business process designers the ability to design processes from any web capable computer. This also allows business process designers to save time when designing a business process, through the use of the pre-built templates.

### CROSS-REFERENCE TO RELATED APPLICATIONS

The present application claims benefit to U.S. Patent Application No. 60/896,417, WEB PROCESS TEMPLATES, filed on Mar. 22, 2007; and U.S. Patent Application No. 60/939,272, METHODS AND APPARATUS FOR PROVIDING CONTEXT SENSITIVE TEMPLATES FOR A WEB BASED WORKFLOW DESIGN, filed on May 21, 2007, the entire contents of which are incorporated herein by reference.

### BACKGROUND

A business process is a combination of operational steps or activities that a business undertakes. A business may conduct a high number of business processes throughout the course of a day or year. An operational step or activity may be any action from the mundane to the complex.

Through the use of technology, businesses can now model their business processes in a graphical nature. What used to be a loosely defined set of procedures can now be formalized into complex business process workflows. The formalized business processes allow managers to understand the bottlenecks of a process, and to redesign the business processes for efficiency.

Additionally, business can now incorporate business process design into their existing technology systems. Instead of providing a simple map of a business process, integration with computer systems allows business process designers to design interactive business processes that drive business workflow. Business process designers can receive data from various sources and perform a wide range of actions on the data directly, and create business processes in an easy to understand visual manner.

Businesses create workflows as a part of business process design to assist in managing their internal operations. Business processes allow users to represent the current state of their business operations in a graphical manner. Users can also simulate new business operations through the use of business processes.

Most business process design software is based on a client machine that is connected to a business process server. However, the client machine connected to a business process server system limits the business process designer's ability to work away from a client machine with the proper access and software.

### SUMMARY

The present disclosure provides methods and apparatuses for providing context sensitive templates for a web based workflow design. Using the methods and apparatus herein, users can create business processes using pre-built templates that define process logic via a web browser. This allows business process designers the ability to design processes from any web capable computer. This also allows business process designers to save time when designing a business process, through the use of the pre-built templates.

Additional features and advantages are described herein, and will be apparent from, the following Detailed Description and the figures.

### BRIEF DESCRIPTION OF THE FIGURES

FIG. 1 is a high level block diagram of an example workflow design system.

FIG. 2 is a more detailed block diagram showing one example of a client device.

FIG. 3 is a more detailed block diagram showing one example of a server.

FIG. 4 is a screenshot of an example web based workflow design template screen.

### DETAILED DESCRIPTION

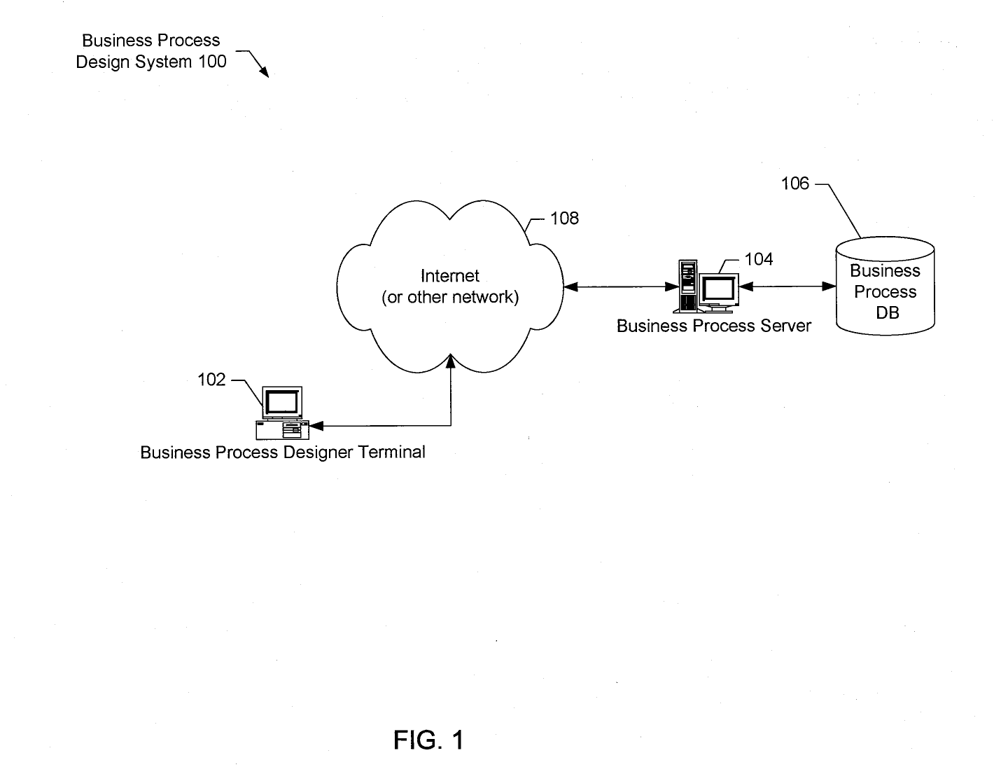

The present system is most readily realized in a network communications system. A high level block diagram of an exemplary network communications system 100 is illustrated in FIG. 1. The illustrated system 100 includes one or more business process designer terminals 102, one or more business process servers 104, and one or more business process databases 106. Each of these devices may communicate with each other via a connection to one or more communications channels 108 such as the Internet or some other data network, including, but not limited to, any suitable wide area network or local area network. It will be appreciated that any of the devices described herein may be directly connected to each other instead of over a network.

The business process server 104 stores a plurality of files, programs, and/or web pages in one or more business process databases 106 for use by the business process designer terminals 102. The business process database 106 may be connected directly to the business process server 104 or via one or more network connections. The business process database 106 preferably stores business process data.

One business process server 104 may interact with a large number of business process designer terminals 102. Accordingly, each business process server 104 is typically a high end computer with a large storage capacity, one or more fast microprocessors, and one or more high speed network connections. Conversely, relative to a typical business process server 104, each business process designer terminal 102 typically includes less storage capacity, a single microprocessor, and a single network connection.

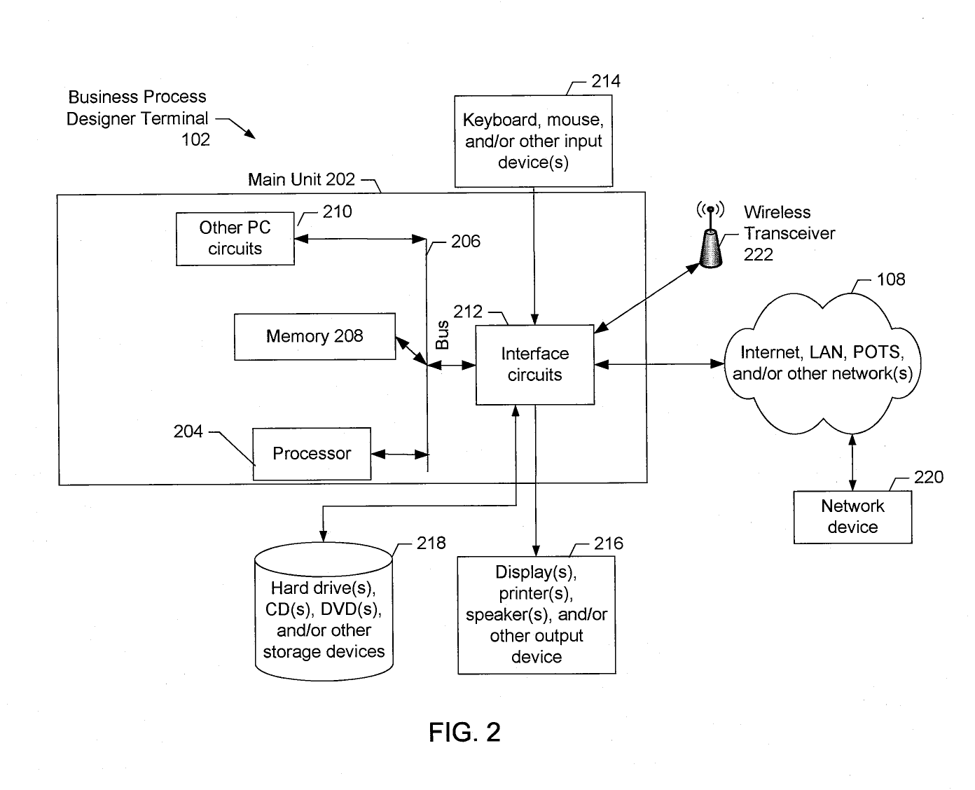

A more detailed block diagram of a business process designer terminal 102 is illustrated in FIG. 2. The business process designer terminal 102 may include a personal computer (PC), a personal digital assistant (PDA), an Internet appliance, a cellular telephone, or any other suitable communication device. The business process designer terminal 102 preferably includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with one or more of the other devices in the system 100 as described below. This program may be executed by the processor 204 in any suitable manner. The memory 208 may also store digital data indicative of documents, files, programs, web pages, etc. retrieved from one or more of the other devices in the system 100 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the business process designer terminal 102. For example, the display 216 may be used to display web pages received from the business process server 104. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the business process designer terminal 102. The storage device 218 may store templates.

The business process designer terminal 102 may also exchange data with other network devices 220 via a connection to the network 112. The network connection may be any type of network connection, such as an Ethernet connection, digital subscriber line (DSL), telephone line, coaxial cable, etc. Users of a business process designer terminal 102 may be required to register with the business process server 104. In such an instance, each user of a business process designer terminal 102, may choose a user identifier (e.g., e-mail address) and a password which may be required for the activation of services. The user identifier and password may be passed across the network 108 using encryption built into the business process designer terminal 102 browser. Alternatively, the user identifier and/or password may be assigned by the business process server 104.

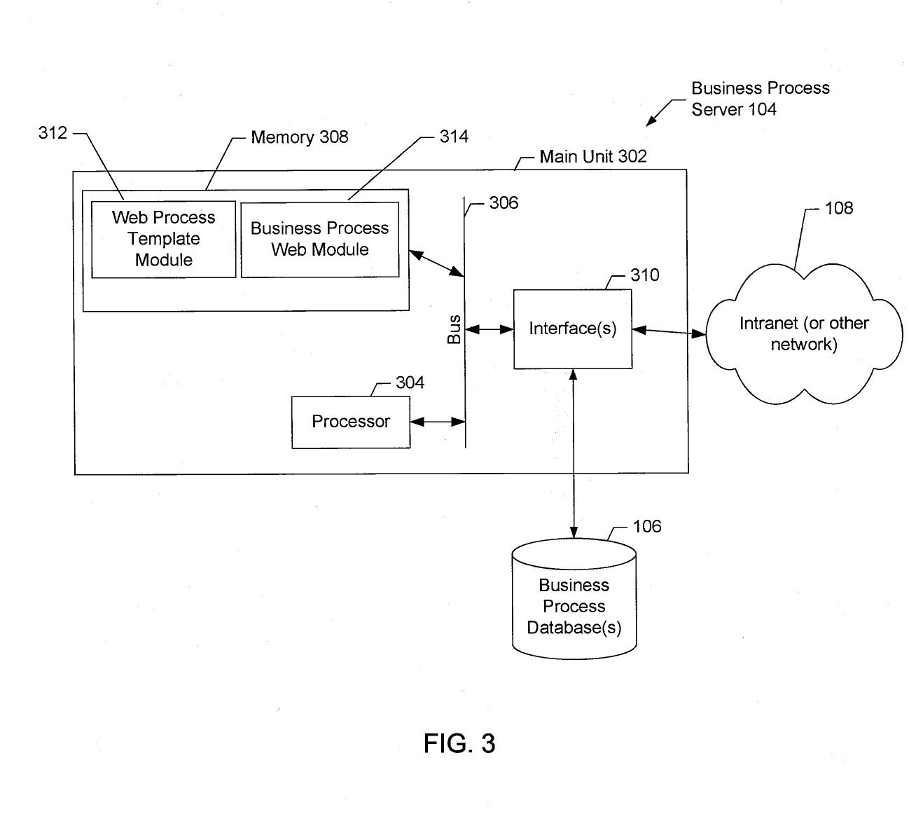

A more detailed block diagram of a business process server 104 is illustrated in FIG. 3. Like the business process designer terminal 102, the main unit 302 in the business process server 104 preferably includes one or more processors 304 electrically coupled by an address/data bus 306 to a memory device 308 and a network interface circuit 310. The network interface circuit 310 may be implemented using any suitable data transceiver, such as an Ethernet transceiver. The processor 304 may be any type of suitable processor, and the memory device 308 preferably includes volatile memory and non-volatile memory. Preferably, the memory device 308 stores a software program that implements all or part of the method described below.

In particular, the memory 308 preferably stores a web process template module 312 and business process web module 314. The web process template module 312 may associate business processes with templates. For example, a template may consist of two connected business process activities, including process logic that will determine a path to take. The process logic, also referred to as actions, outcomes, etc., may be automatically displayed to the business process designer as a form that the business process designer can enter data into.

The business process web module 314 may present the business process design elements to the business process designer, and allow the business process designer to fully develop the business process on a single web page, canvas, etc. For example, the business process web module 314 may receive asynchronous calls from the business process designer terminal 102 and the business process designer may be able to use the web based process designer without the need to refresh the web page (no post-back).

The business process web module 314 may also allow for drag-and-drop capabilities so that the business process designer can receive immediate visual feedback. For example, the business process web module 314 may transmit a web page to the business process designer terminal 102 that includes a number of drag and drop templates that the business process designer may use in designing the business process. In another example, the business process web module 314 transmits a drag and drop visual representation of a list of users and or groups that have access to perform a type of business process step.

The business process web module 314 may also transmit a list of available destination locations for documents in a business process. For example, the business process web module 314 may transmit a graphical folder view of available destinations for documents in a business process.

The web process template module 312 and the business process web module 314 allows the business process designer to design a business process entirely on the web using pre-built templates without needing to refresh the browser on the business process designer terminal 102.

For example, a business process designer may wish to create a document routing process. The business process designer may drag an “Approve/Decline Process” template to the canvas and logic for determining what Actions to display to content approvers is automatically generated by the web process template module 312 and the business process web module 314. The branching logic for “Approve” and “Decline” may also be automatically generated. The form that the approver must use to action the item may be generated. The business process web module 314 may have already transmitted the commands to visually prompt the business process designer to provide a list of users to route the document to. The context of the users who have read/write rights to the repository may be preserved as well as grouping mechanisms of the storage system.

The business process designer may need to configure an event to manage the moving of an approved document. For example, the business process designer may drag a “Document Move Wizard” to the “Approved” task and provide the destination location for the document. The business process designer may drag a “Mail” event wizard onto the “Approved” and “Declined” tasks and identify which elements belong in the body of the email. The completed business process may be stored by the business process web module 314 into the business process database 106.

The web process template module 312 and the business process web module 314 also allows the business process designer to design custom templates, or use existing workflows as templates for future use.

For example, a business process designer may wish to create a new template. The web process template module 312 allows the business process designer to create images, set pre-defined logic constructs, create graphical representations of the pre-defined logic constructs, and set default values for wizard components. The web process template module 312 also allows the custom template to be shared. For example, the web process template module 312 may store the custom template in the business process database 106.

The web process template module 312 also allows the business process designer to select an existing workflow and use the workflow as a template for a new workflow. For example, the business process designer may select a “Customer Order” template and create a “Business Partner Order” using the “Customer Order” workflow as a template.

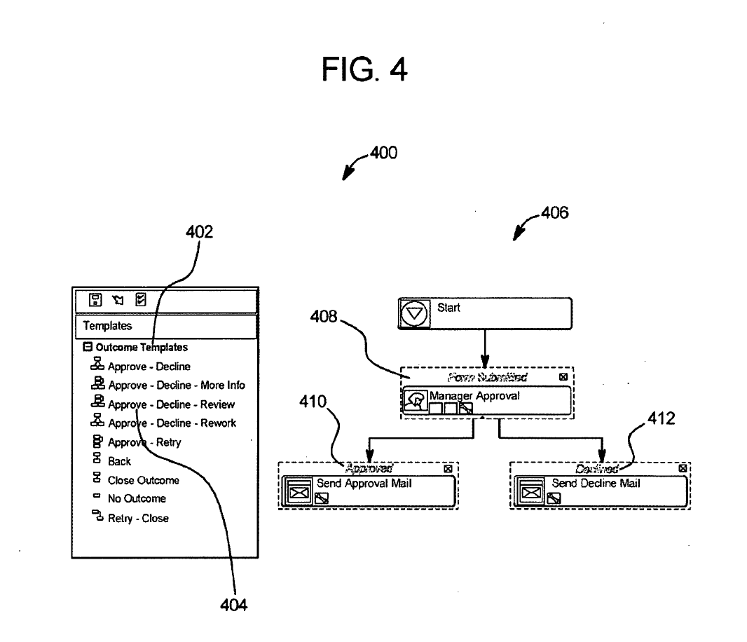

A screenshot of an example web based workflow design template screen 400 is presented in FIG. 4. Although the example web based workflow design template screen 400 is described in reference FIG. 4, it will be appreciated that many other configurations are possible. For example, elements could be in different locations, elements could have different names, and elements could have different graphical representations.

The web based workflow design template screen 400 may have a templates toolbar 402. The templates toolbar may contain a folder listing of a number of pre-built templates. For example, the templates toolbar may include an “Approve-Decline” template, an “Approve—Decline—More Info” template, etc.

In one example, the business process designer selects the “Approve—Decline—Review” template 404. The business process designer drags and drops the icon for the “Approve—Decline—Review” template 404 onto the canvas 406. The web process template module 312 may have associated the “Approve—Decline—Review” template 404 with a “Form Submitted” activity 408 that has an associated “Manager Approval” event, an “Approved” activity 410 that has an associated “Send Approval Mail” event, and a “Declined” activity 412 that has an associated “Send Decline Mail” event.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for providing context sensitive templates comprising:
creating a template for a business process workflow, wherein the template comprises at least one business process object;
selecting the template;
inserting the template into a business process workflow; and
configuring the template based on the business process workflow.

2. The method of claim 1, wherein a setting wizard is associated with the template.

3. The method of claim 1, wherein creating a template includes creating an image, setting a pre-defined logic construct, creating a graphical representation of the pre-defined logic construct and setting a default value for a wizard component.

4. The method of claim 1, wherein selecting the template includes selecting the template from a plurality of predetermined templates.

5. The method of claim 1, wherein inserting the template includes inserting branching logic associated with the template.

6. The method of claim 1, wherein configuring the template includes associating read/write rights with the template based on read/write rights associated with the business process workflow.

7. A system for providing context sensitive templates comprising:
a first memory capable of storing a template; and
a processor to create a template for a business process workflow, wherein the template is at least one business process, to insert the template into a business process workflow, and to configure the template based on the business process workflow.

8. The system of claim 7, wherein a setting wizard is associated with the template.

9. The system of claim 7, wherein creating a template includes creating an image, setting a pre-defined logic construct, creating a graphical representation of the pre-defined logic construct and setting a default value for a wizard component.

10. The system of claim 7, wherein the first memory is capable of storing a plurality of predetermined templates.

11. The system of claim 7, wherein the processor inserts branching logic associated with the template.

12. The system of claim 7, wherein the processor associates read/write rights with the template based on read/write rights associated with the business process workflow.

13. A computer readable medium storing instructions structured to cause a computing device to:
create a business process workflow template, wherein a template comprises at least one business process object;
select the template;
insert the template into a business process workflow; and
configure the template based on the business process workflow.

14. The computer readable medium of claim 13, wherein a setting wizard is associated with the template.

15. The computer readable medium of claim 13, wherein creating a template includes creating an image, setting a pre-defined logic construct, creating a graphical representation of the pre-defined logic construct and setting a default value for a wizard component.

16. The computer readable medium of claim 13, wherein the instructions are structured to cause the computing device to select the template from a plurality of predetermined templates.

17. The computer readable medium of claim 13, wherein the instructions are structured to cause the computing device to insert branching logic associated with the template.

18. The computer readable medium of claim 13, wherein the instructions are structured to cause the computing device to associate read/write rights with the template based on read/write rights associated with the business process workflow.
